(19) United States
(12) Patent Application Publication
(10) Pub. No.: US 2021/0399974 A1
(43) Pub. Date: Dec. 23, 2021

(54) Delay-Based Micro-Loop Prevention in IGP Routing

(71) Applicant: Telefonaktiebolaget LM Ericsson (publ), Stockholm (SE)

(72) Inventors: Gundu Sikhivahan, Bangalore (IN); Debojyoti Guha, Bengaluru (IN)

(21) Appl. No.: 17/292,802

(22) PCT Filed: Nov. 13, 2018
(86) PCT No.: PCT/IN2018/050735

§ 371 Date: May 11, 2021

(51) Int. Cl. H04L 12/757; H04L 12/733; H04L 12/717; H04L 12/721; H04L 12/707

(52) U.S. Cl. CPC H04L 45/023; H04L 45/122; H04L 45/22; H04L 45/123; H04L 45/42

(57) ABSTRACT

To determine whether to a delay a routing update, a router generates graphs of the network topology before and after the failure of a link or node and compares the graphs to identify changes in the network topology. Based on an analysis of the changes, the router determines whether to implement, continue and/or abort a preconfigured delay for making routing updates.

### TECHNICAL FIELD

The disclosure relates generally to packet routing in Interior Gateway Protocol (IGP networks and. More particularly, to delay-based prevention .micro-loops during routing updates.

### BACKGROUND

In a typical packet-switched network, such as an Internet Protocol (IP) network or Multi-Protocol Label Switching (MPLS)/Label Distribution Protocol (LDP) network, each network node, e.g. router or switch, computes a shortest path to each destination and uses the shortest path for routing in non-failure conditions. The routes or paths to each destination in the network are stored in a routing table. When a link or another node attached to an IP router fails, a routing table is computed based on the new network topology. Computation of the new routing table can take between hundreds of milliseconds to a few seconds. If the previous routing table is used until the new routing table is computed, packets going through the failed link/node would be lost, potentially causing service disruption.

Fast Rerouting (FRR) solutions provide protection against link or node failures by computing in advance alternate routes, also called backup routes, that can be activated instantly when a link or node failure occurs. Initially, the source router is using a primary path (PATH-1) to a destination. When a link/node fails, it switches to a backup path (PATH-B) while it re-computes routing tables. Traffic is routed over the backup path while the new routing table is computed thereby avoiding traffic loss. When the new table has been computed, the router switches to a new primary path (PATH-2).

One requirement for a viable backup path is that it should be “loop-free”, i.e., packets must be able to reach the destination without looping between nodes. Loop-free alternatives (LFAs) avoid traffic loss by sending traffic to a neighboring node that can forward the traffic to destination without looping back to source. Remote LFAs can be used if a LFA does not exist. RLFAs use LDP tunnels to tunnel traffic to a non-neighbor “release node” from which the traffic can be forwarded to the destination without looping back to the source. The Internet Engineering Task Force (IETF) describes high-level algorithms to compute Loop-Free Alternates (LFA, RFC5286) and Remote Loop-Free Alternates (RLFA, RFC7490, RFC 8102). Another technique called Topology-Independent LFA (TI-LFA, proposed IETF standard) is used in segment routing networks to provide loop-free backup paths. TI-LFA differs from RLFA by constraining the backup-path computation problem to require that, topologically, the backup path (PATH-B) must be the same as the primary path (PATH-2) after the router re-converges following a link/node failure.

When a router detects a failure of an incident link, it announces the failure by sending a link-state packet. The announcement propagates through the network and each router recomputes its routing tables based on the new network topology. It takes some time for the announcement of the link failure to propagate through the network and for the routers to converge on a common view of the new network topology. There will be differences in the amount of time needed for different routers to update their routing tables. Thus, during the routing transition period, different routers may be using inconsistent routing tables and micro-loops may occur as a result. For example, a micro-loop may occur if the source router updates its routing table and begins forwarding to a neighbor before the neighbor has had time to update its own routing tables. In this example, the neighbor will forward packets based on the previous routing table, which can cause a micro-loop. Although micro-loops may be transitory, these micro-loops can nevertheless cause network congestion of loss of packets.

Routers can avoid micro-loops in some circumstances by delaying copying of the routing updates from the control-plane to forwarding-plane to provide time for the network to converge on a common view of the new network topology. Version 9 of an Internet Draft published by IETF titled “Micro-loop prevention by introducing a local convergence delay”, describes the use of a convergence delay to prevent local transient micro-loops in case of a link failure. When the failure of an incident link is detected, copying of affected routes to the forwarding plane is delayed for a configured period of time. During this delay period, traffic is forwarded over a backup path that is guaranteed to be loop-free. The delay gives the rest of the network time to “catch up” with the link failure, so when the delay period expires and source router's forwarding tables are updated, the packets travel over new primary paths without looping.

The solution outlined by the IETF handles failure of one incident link of the source router. The solution requires that a link failure be detected by looking at the link-state packet that announces the failure of the link. The detailed logic for detection is not. specified and is left to the network implementation. The solution also mandates that the delay be aborted (and the risk of micro-loop re-introduced) if a subsequent event/convergence occurs before the delay period expires, even if that event is not a second link failure.

### SUMMARY

The present disclosure relates generally to micro-loop prevention following a link failure or node failure. A router generates graphs of the network topology before and after a link failure or node failure, and compares the graphs to identify changes in the network topology. Based on an analysis of the changes, the router determines whether to implement a delay, or to abort a delay already in force.

One aspect of the disclosure comprises methods implemented by a router in a communication network of making routing updates. The router determines an initial topology of a communication network prior to a failure of a network node or link in the communication network. The router detects the failure of the network node or link, determines a new topology of the communication network resulting from the failure, and computes a new routing table based on the new topology. The router further determines whether to delay activation of the new routing table based on a comparison of the new topology with the initial topology determined before the failure.

Another aspect of the disclosure comprises a router in a packet-switched communication network including a packet forwarding unit and a routing unit. The packet forwarding unit is configured to receive packets over the packet-switched communication network and to forward the received packets toward a respective destination. The routing unit is configured to determine an initial topology of a communication network prior to a failure of a network node or link in the communication network. The routing unit is further configured to detect the failure of the network node or link, determine a new topology of the communication network resulting from the failure, and compute a new routing table based on the new topology. The routing unit is further configured to determine whether to delay activation of the new routing table based on a comparison of the new topology with the initial topology determined before the failure.

Another aspect of the disclosure comprises a computer program product for a router in a packet-switched communication network. The computer program product comprises program instructions that when executed causes the router to determine an initial topology of a communication network prior to a failure of a network node or link in the communication network. The computer program further includes instructions that when executed cause the router to detect the failure of the network node or link, determine a new topology of the communication network resulting from the failure, and compute a new routing table based on the new topology. The computer program further includes instructions that when executed cause the router to determine whether to delay activation of the new routing table based on a comparison of the new topology with the initial topology determined before the failure The computer program product may be in a carrier, such as a non-transitory computer readable medium.

Embodiments of the present disclosure provide greater flexibility to network operators in handling events and allows network operators to implement their own policies in deciding whether to implement a delay or to abort a delay already in progress. Generally, aborting a delay is not desirable because it may lead to micro-loops. The techniques herein described enable network operators to apply a delay even though current practices would mandate that the delay be aborted.

### BRIEF DESCRPTION OF THE FIGURES

FIG. 1 illustrates an exemplary network in a pre-failure condition.

FIG. 2 illustrates the exemplary network with a link failure on the link S-B.

FIG. 3 illustrates the exemplary network with a link failure on the link S-B and link B-D.

FIG. 4 illustrates an exemplary method for making routing updates according to an embodiment.

FIG. 5 illustrates one example of logic for determining whether to delay a routing update.

FIG. 6 illustrates another example of logic for determining whether to delay a routing update.

FIG. 7 illustrates another example of logic for determining whether to delay a routing update.

FIG. 8 illustrates another example of logic for determining whether to delay a routing update.

FIG. 9 illustrates another example of logic for determining whether to delay a routing update.

FIG. 10 illustrates another example of logic for determining whether to delay a routing update.

FIGS. 11A and 11B illustrates another method for making routing updates according to an embodiment.

FIG. 12 illustrates an exemplary router according to an embodiment.

### DETAILED DESCRIPTION

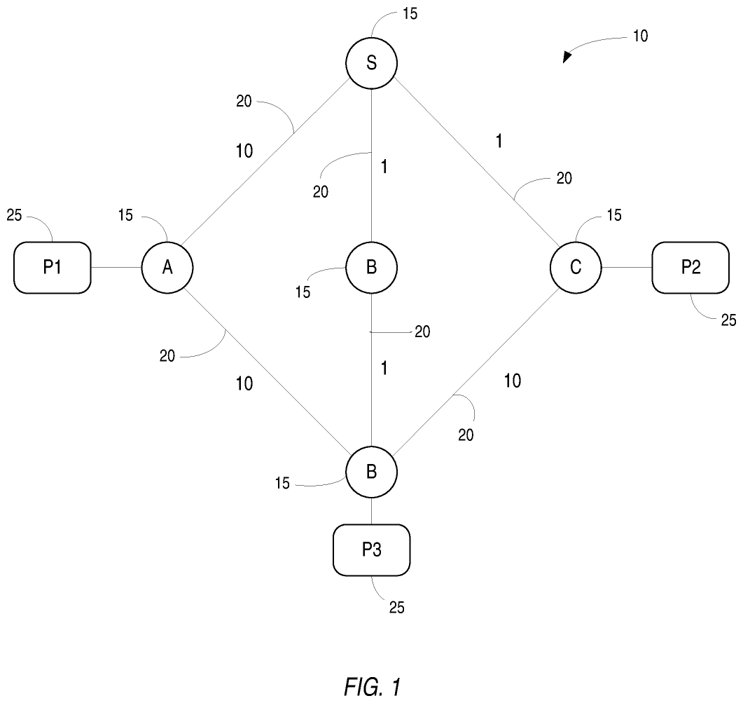

Referring now to the drawings, FIG. 1 illustrates an exemplary communication network 10 which is used for purposes of explanation. The communication network 10 comprises a plurality of routers 15 interconnected by links 20. The routers 15 are indicated individually by letters A-D and S, where S represents the source router. Links are denoted individually by reference to the nodes at each end of the link. For example, the link between source router S and router H is referred to as link S-H. Routers A-D connect to respective destinations 25, which are denoted individually as destinations P1-P3. The numbers adjacent each link 20 represent the cost associated with the link for use in SPF computations.

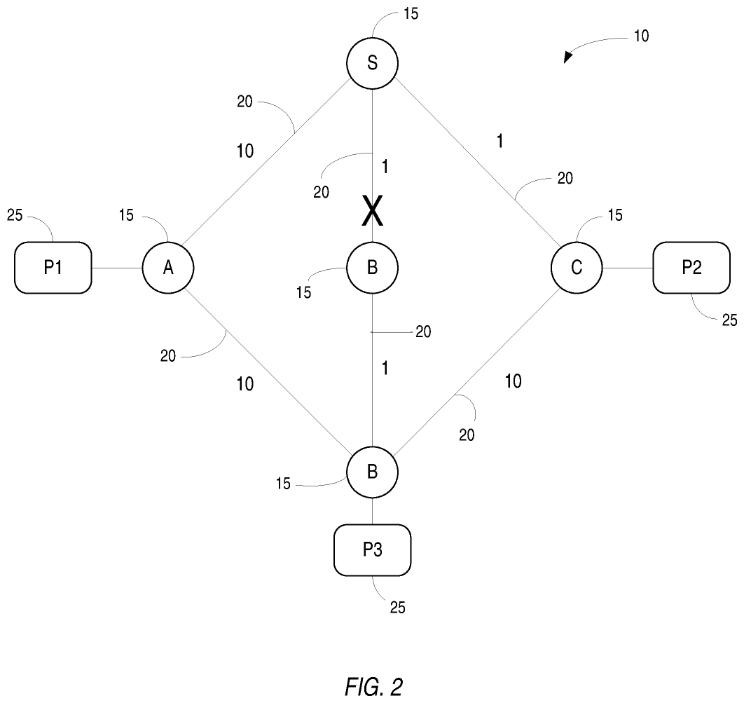

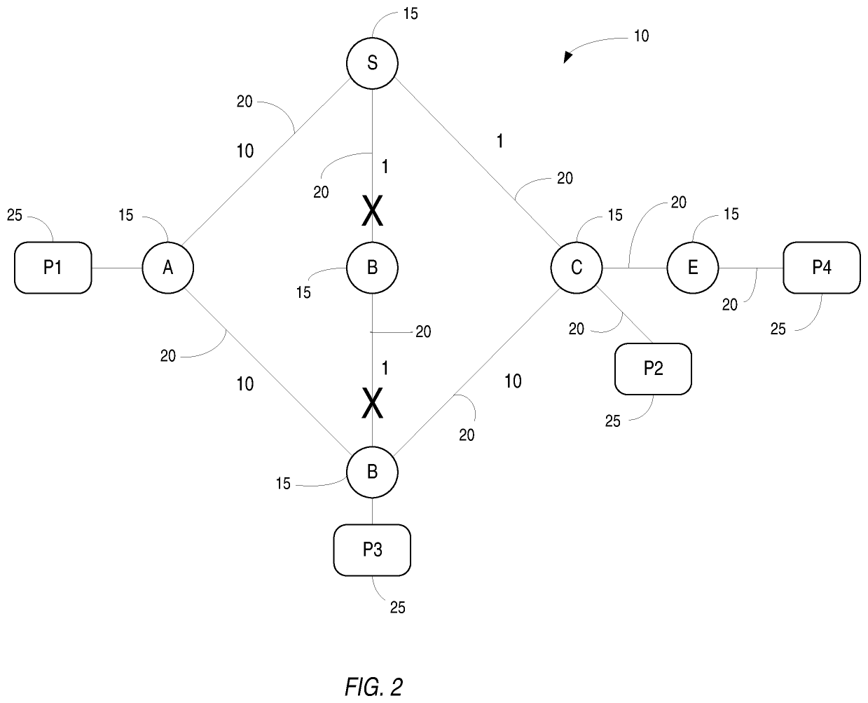

FIG. 2 illustrates the same communication network 10 as shown in FIG. 1 following a failure of the link between S and B. When the link S-B fails, the source router S temporarily switches to a backup path (PATH-B) while it re-computes routing tables. Traffic is routed over a backup path while the new routing table is computed thereby avoiding traffic loss. One requirement for a viable backup path is that it should be “loop-free”, i.e., packets must be able to reach the destination without looping between nodes. When the new routing table has been computed, the router switches to the new primary path (PATH-2). In this example, S will forward packets intended for destination P3 to C following the routing update.

A problem arises when S updates its routing tables while C is still using a routing table based on the “old” network topology. In his case, C will forward packets addressed to P3 back to S, resulting in a micro-loop. To avoid such micro-loops, S can implement a pre-configured delay before installing the routing updates to the forwarding plane to give C time to update its own routing tables. During the delay period, S can forward packets for P3 using a loop-free backup path. In the case, a loop-free backup path exists, so S forwards packets to A, from which packets will be forwarded to P3 without looping.

FIG. 3 illustrates the same communication network assuming a second link failure of the link between B and D before the expiration of the delay period, i.e. before S installs the new routing tables in the forwarding plane. Additionally, a new link appears between C and E. Under the proposed IETF solution, S must abort the delay period with the risk that a micro-loop will occur.

Embodiments of the present disclosure provide a more flexible approach by allowing the router to consider the impact of other events in determining whether to abort the delay. In the example shown in FIGS. 2 and 3, aborting the delay creates a rick of micro-loops without providing any benefit. The new path to P3 swill be the same regardless of the link failure between B and D. In embodiment of the present disclosure, the router is allowed to perform a “deeper” analysis of changes to the network topology and determine whether to abort the delay based on its analysis of the changes. In this example, a router implementing the techniques herein described may decide not to abort the delay.

According to an aspect of the present disclosure, the router 15 generates graphs of the network topology before and after the failure of a link or node and compares the graphs to identify changes in the network topology. Based on an analysis of the changes in network topology, the router 15 determines whether to implement and/or abort a delay for making routing updates.

In one embodiment, the implementation of a delay is handled as follows by a router 15 implementing an Interior Gateway Protocol (IGP) such as the Intermediate System-to-Intermediate System (ISIS) protocol or Open Shortest Path First (OSPF) protocol. The router 15 parses link-state packets in the link-state database, and constructs an initial network topology in the form of a graph data structure. Pseudo-nodes are replaced with the actual connectivity relationships they imply. The vertexes of the graph represent routers 15, and are stored as a dynamically allocated array denoted herein as Netnodes. Each element of the Netnodes embeds another array, which represents the incident links of a router 15 in the form of neighbors at the end of those links. This array is denoted herein as Nodenbrs. For example, Netnodes[i].Nodenbrs[j] contains information about the j'th neighbor of i'th router 15. The Netnodes array and all of the Nodenbrs arrays are sorted by router-id, effectively indexing the arrays by router-id. The graph of the initial network topology is stored in a variable called CurrentTopo.

In the example shown in FIG. 1, CurrentTopo for S is as follows:

CurrentTopo.Netnodes={S, A, B C, D}

CurrentTopo.Nodebrs={{A, B, C}, {S, D}, {S, D], {S, D}, {A, B, C}}

Note that the members Nodebrs correspond to members of Netnodes in the same order. Thus, CurrentTopo.Nodebrs[D]={A, B, C}.

When a SPF calculation is triggered (e.g. responsive to a link or node failure), the router 15 generates a new topology graph as described above describing the new network topology. This new network topology is stored in a graph called NewTopo.

In this example shown in FIG. 2, NewTopo for S is as follows:

NewTopo.Netnodes={S, A, B C, D}

NewTopo.Nodebrs={{A, C}, {S, D}, {S, D], {S, D}, {A, B, C}}

The router 15 compares the graphs stored by CurrentTopo and NewTopo and makes a list of the differences. The differences are computed in terms of the events that have transformed CurrentTopo to NewTopo. These events are link-down events and link-up events. Node-down events and Node-up events are also reduced to link-down and link-up events. The router enumerates the differences between CurrentTopo and NewTopo and stores them in a variable called TopoDiffs. TopoDiffs contains two arrays referred to as the DownLinks array and UpLinks array. The DownLinks array comprises a list of “downlinks” that are present in the initial network topology but not present in the new network topology. The UpLinks array comprises a list of “uplinks” that are not present in the initial network topology but are present in the new network topology. DownLinks and UpLinks are initially empty.

The router 15 compares the NetNode arrays in CurrentTopo and NewTopo. If a node is present in CurrentTopo but not in NewTopo, all of its links are added to TopoDiff.DownLinks. If a node is present in NewTopo but not in CurrentTopo, all of its links are to TopoDiffUpLinks. If a node is present in both, the router 15 compares the Nodenbrs arrays associated with the node in CurrentTopo and NewTopo. If a link is present in CurrentTopo. Nodenbrs but not in NewTopo. Nodenbrs, the router 15 adds it to TopoDiff.DownLinks. If the opposite, the router 15 adds it to TopoDiff. UpLinks.

In the example shown in FIG. 2, TopoDiffs is as follows:

TopoDiffs.Downlinks={S→B}

TopoDiffs.Uplinks={ }

In some embodiments, the process of enumerating events maybe “short-circuited” for performance reasons to terminate as soon as a certain event (i.e., a second link failure) is detected, or it may be allowed to run to completion to collect a full set of events.

After the changes in network topology are enumerated and stored in TopoDiffs, the router sets CurrentTopo equal to NewTopo. At this point, the router 15 determines whether to implement a pre-configured delay, and or abort a delay already in progress. To make this decision, the router 15 looks at the events in TopoDiffs, which includes a complete list of all events that have occurred. Depending on the enumerated events, the router 15 decides to whether to implement a delay (e.g., start a delay timer), or to abort an ongoing delay (e.g., stop a delay timer).

In this example, the length of TopoDiff.DownLinks is 1, and points to a link incident to router 15 that is protected by a backup path. In this case, the router 15 may decide to apply the delay timer to the update of P3's routing entry. Optionally, the router 15 may also consider TopoDiff. Uplinks and implement the delay optionally only if:

1) TopoDiff. Uplinks is not Null; or

2) if no link incident to router is in TopoDiff. UpLinks.

As another example, the router 15 may decide to abort a delay timer currently in force if:

1) TopoDiff. UpLinks is not Null, or

2) any incident link to router 15 is in TopoDiff. UpLinks.

To further explain the advantages of using topology changes, assume that the topology changes shown in FIG. 3 occur while the delay is in force, i.e. the delay time is active. In this example, NewTopo for S and TopoDiffs is as follows:

NewTopo.Netnodes={S, A, B C, D, E}

NewTopo.Nodebrs={{A, C}, {S, D}, {S, D}, {S, D, E}, {A, C, {C}}

TopoDiffs.Downlinks={S→B, B→D}

TopoDiffs.Uplinks={C→E}

Noting that two links have failed, the router S may decide to abort the delay, preferring to take the risk of micro-loops. Alternatively, the router 15 may opt to perform a deeper analysis of the topology changes and decide that the topology changes do not cause any additional complications. In this case, the additional downlink on the path from S to D does not cause any complications because B is not on the path to P# for any of the routers 15. Also, the link C-E not being incident to S does not create a new complication. Thus, the router 15 may choose to implement a delay or continue a delay currently in force to avoid micro-loops caused by the failure of the link S-B.

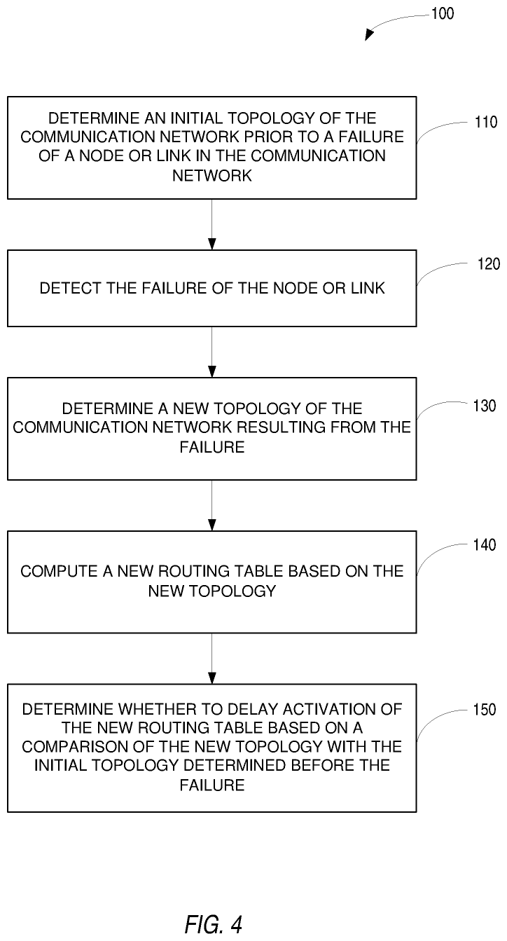

FIG. 4 illustrates an exemplary method 100 implemented by a router 15 according to one exemplary embodiment. The method 100 is used to make routing updates following a link or node failure. Prior to the failure of a link of node, the router 15 determines an initial network topology of the communication network (block 110). Subsequently, the router 15 detects the failure of a link or node (block 120). Responsive to detection of the link or node failure, the router 15 determines a new network topology resulting from the link or node failure and computes a new routing table based on the new topology (blocks 130 and 140). After computing the routing updates, the router 15 determines whether to delay activation of the new routing table based on a comparison of the new topology with the initial topology determined before the failure (block 150).

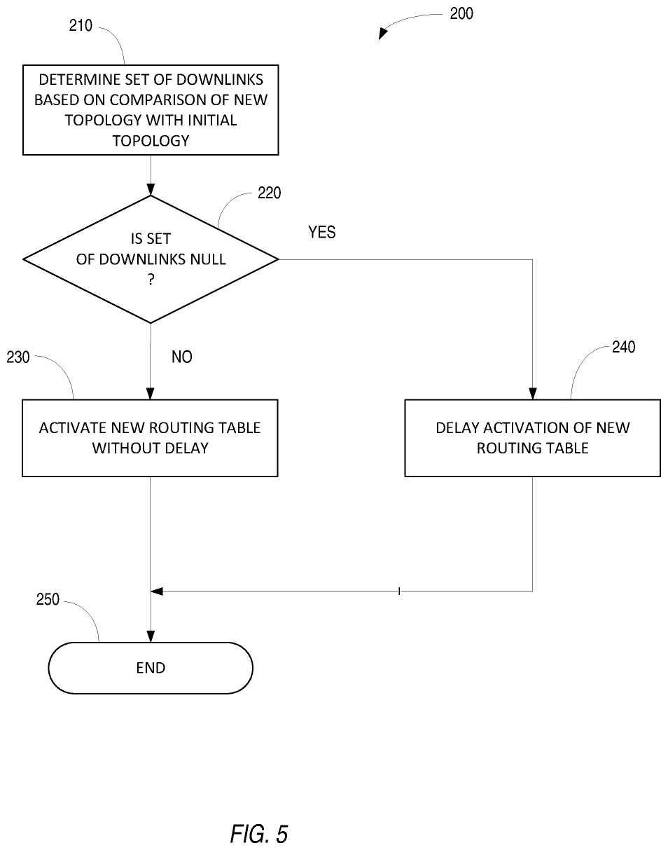

FIG. 5 illustrates exemplary logic 200 used by router 15 to decide whether to implement or abort the delay. Logic 200 may be used at block 150 in FIG. 4. In this example, the router 15 determines a set of downlinks based on the comparison of the new network topology with the initial network topology (block 210). If the set of downlinks is determined to be null (block 220), the router 15 delays activation of the new routing table (block 240) and the process ends (block 250). In this case, a delay timer is started if not already in force. If a delay timer is already in force, the delay timer continues, i.e., remains in force, until expiration. If the set of downlinks is determined to be not null (block 220), the router 15 activates the new routing table without delay (block 230) and the process ends (block 250). In this case, the router 15 stops the delay timer if it is already in force and the delay is aborted.

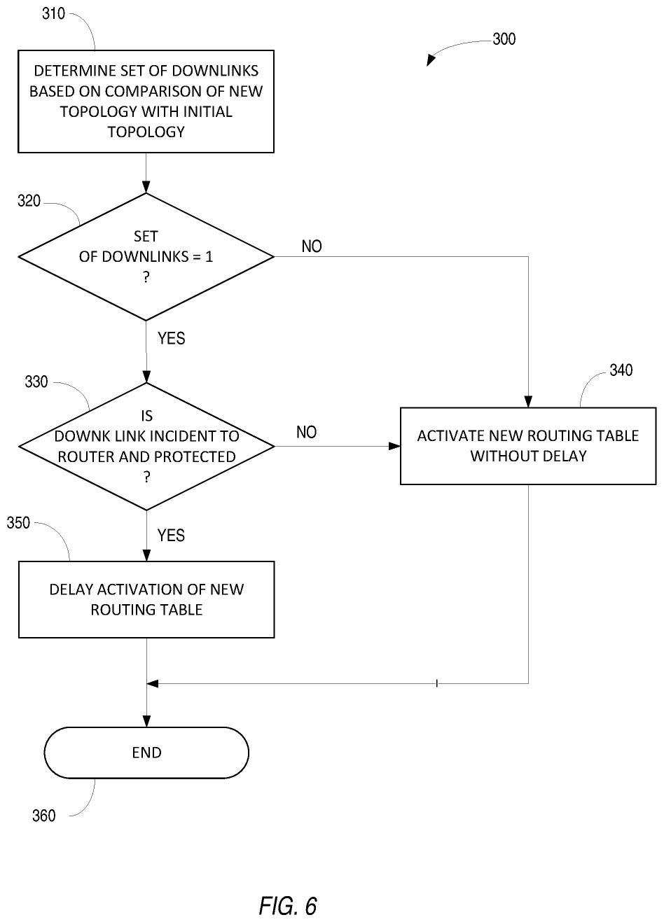

FIG. 6 illustrates another example of logic 300 used by router 15 to decide whether to implement or abort the delay. Logic 300 may be used at block 150 in FIG. 4. In this example, the router 15 determines a set of downlinks based on the comparison of the new network topology with the initial network topology (block 310). If the number of downlinks in the set of downlinks is determined to be 1 (block 320), the router 15 determines if the downlink is a link incident to router 15 and is protected by a backup (block 330). If both conditions are met, the router 15 delays activation of the new routing table (block 340) and the process ends (block 360). In this case, a delay timer is started if not already in force. If a delay timer is in force, the delay timer continues, i.e., remains in force, until expiration. If the router 15 determines at block 320 that the number of downlinks in the set of downlinks is not equal to 1, the router 15 activates the new routing table without delay (block 340) and the process ends (block 360). Similarly, if the router 15 determines at block 330 that the downlink is not incident to the router 15, or is unprotected by a backup path, the router 15 activates the new routing table without delay (block 340) and the process ends (block 360). When the new routing table is activated without delay, the router 15 stops the delay timer if it is already in force and the delay is aborted.

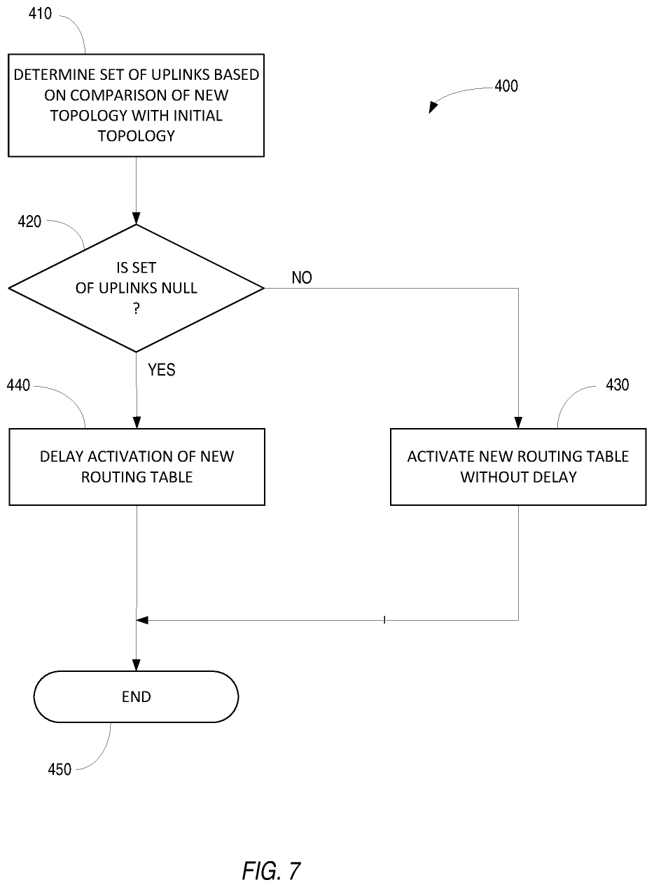

FIG. 7 illustrates exemplary logic 400 used by router 15 to decide whether to implement or abort the delay. Logic 400 may be used at block 150 in FIG. 4. In this example, the router 15 determines a set of uplinks based on the comparison of the new network topology with the initial network topology (block 410). If the set of uplinks is determined to be null (block 420), the router 15 delays activation of the new routing table (block 440) and the process ends (block 450). In this case, a delay timer is started if not already in force. If a delay timer is already in force, the delay timer continues, i.e., remains in force, until expiration. If the set of uplinks is determined to be not null (block 420), the router 15 activates the new routing table without delay (block 430) and the process ends (block 450). In this case, the router 15 stops the delay timer if it is already in force and the delay is aborted.

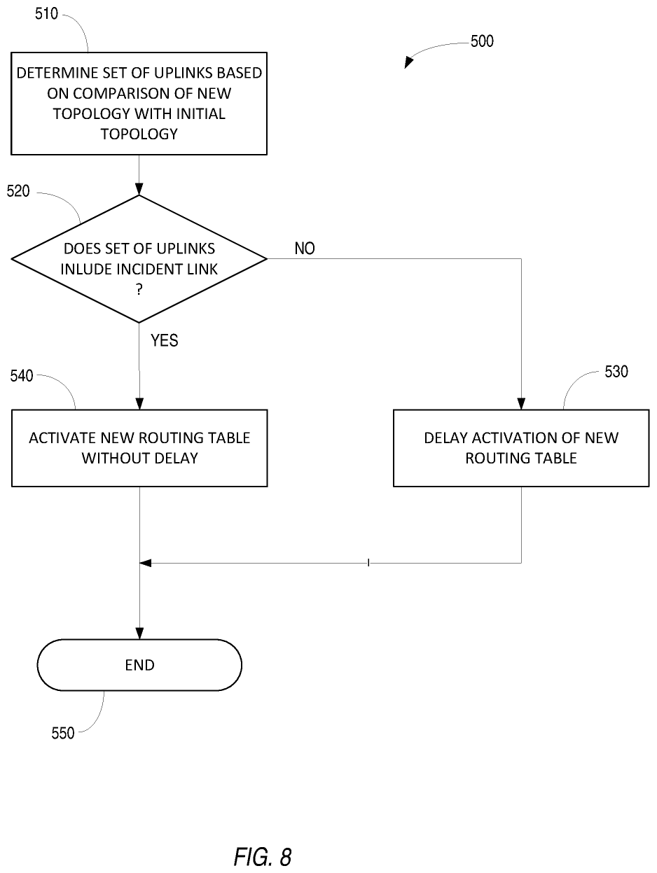

FIG. 8 illustrates exemplary logic 500 used by router 15 to decide whether to implement or abort the delay. Logic 500 may be used at block 150 in FIG. 4. In this example, the router 15 determines a set of uplinks based on the comparison of the new network topology with the initial network topology (block 510). At block 520, the router 15 determines whether the set of uplinks includes a link incident to the router 15 (block 520). If not, the router 15 delays activation of the new routing table (block 530) and the process ends (block 530). In this case, a delay timer is started if not already in force. If a delay timer is already in force, the delay timer continues, i.e., remains in force, until expiration. If the set of uplinks includes a link incident to router 15, the router 15 activates the new routing table without delay (block 540) and the process ends (block 550). In this case, the router 15 stops the delay timer if it is already in force and the delay is aborted.

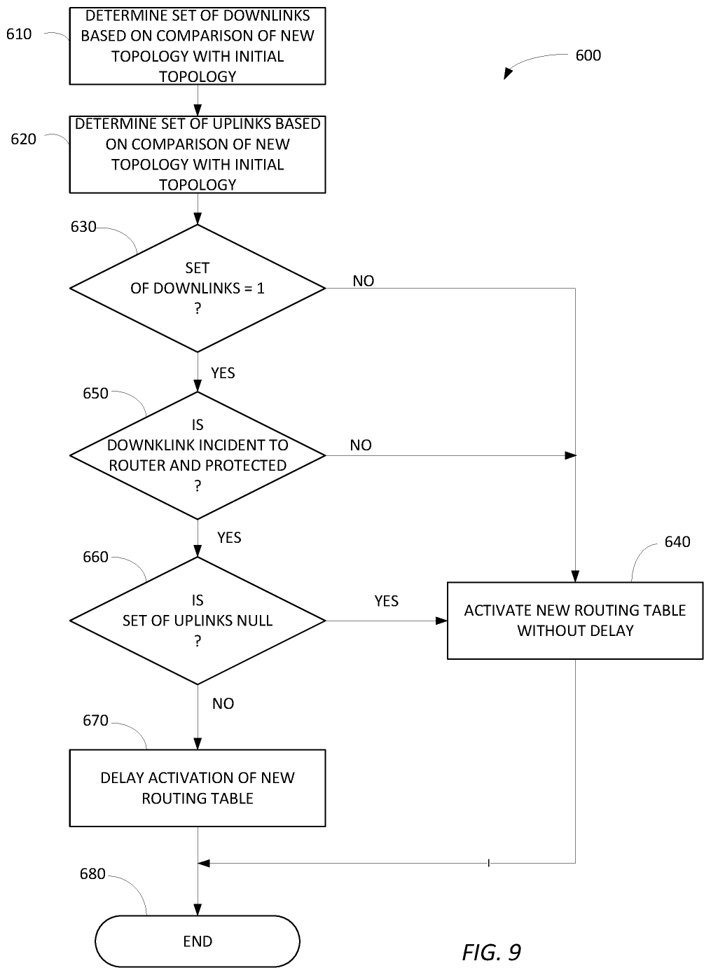

FIG. 9 illustrates another example of logic 600 used by router 15 to decide whether to implement or abort the delay. Logic 600 may be used at block 150 in FIG. 4. In this example, the router 15 determines a set of downlinks based on the comparison of the new network topology with the initial network topology (block 610). The router 15 also determines a set of uplinks based on the comparison of the new network topology with the initial network topology (block 620). At block 630, the router 15 determines whether the number of downlinks in the set of downlinks equals 1. If not, the router 15 activates the new routing table without delay (block 640) and the process ends (block 680). If the number of downlinks in the set of downlinks equals 1, the router determines whether the downlink is incident to the router 15 and is protected by a backup path (block 650). If not, the router 15 activates the new routing table without delay (block 640) and the process ends (block 680). If the downlink satisfies both conditions, the router 15 determines if the set of uplinks is null (block 660). If so, the router 15 activates the new routing table without delay (block 640) and the process ends (block 680). If not, the router 15 delays activation of the new routing table (block 670) and the process ends (block 680). When the new routing table is activated without delay, the router 15 stops the delay timer if it is already in force and the delay is aborted. When activation is delayed, the router 15 starts a delay timer if one is not already in force. If a delay timer is in force, the router 15 allows the delay timer to continue, i.e., remain in force, until expiration.

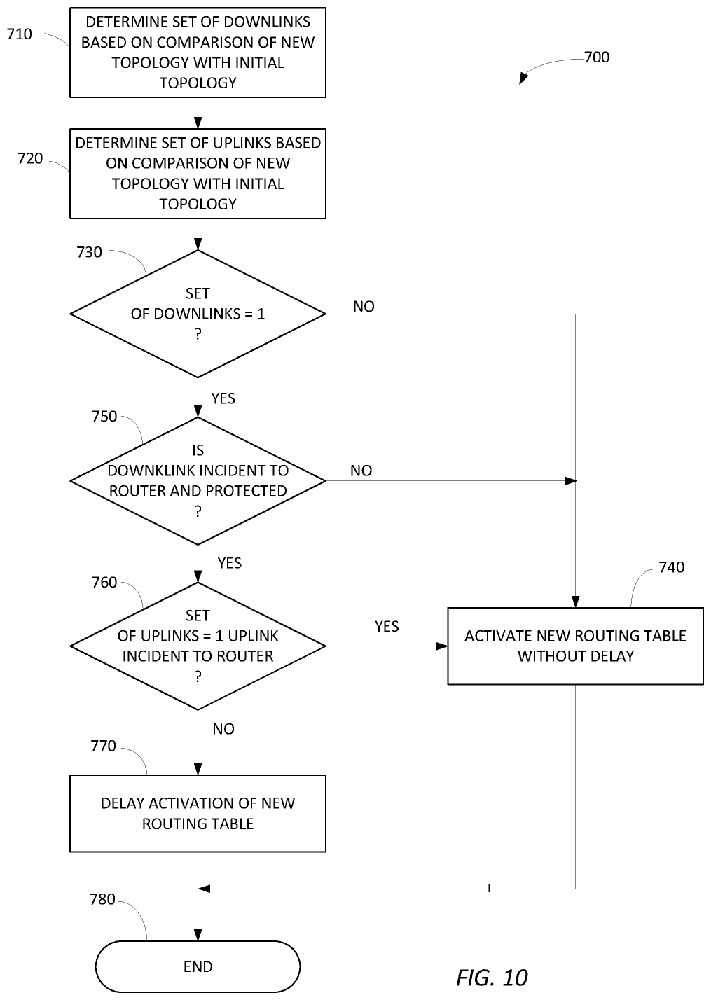

FIG. 10 illustrates another example of logic 700 used by router 15 to decide whether to implement or abort the delay. Logic 700 may be used at block 150 in FIG. 4. In this example, the router 15 determines a set of downlinks based on the comparison of the new network topology with the initial network topology (block 710). The router 15 also determines a set of uplinks based on the comparison of the new network topology with the initial network topology (block 720). At block 730, the router 15 determines whether the number of downlinks in the set of downlinks equals 1. If not, the router 15 activates the new routing table without delay (block 740) and the process ends (block 780). If the number of downlinks in the set of downlinks equals 1, the router determines whether the downlink is incident to the router 15 and is protected by a backup path (block 750). If not, the router 15 activates the new routing table without delay (block 740) and the process ends (block 780). If the downlink satisfies both conditions, the router 15 determines if the number of uplinks in the set of uplinks equals 1 and the uplink is incident to the router 15 (block 760). If so, the router 15 activates the new routing table without delay (block 740) and the process ends (block 780). If not, the router 15 delays activation of the new routing table (block 770) and the process ends (block 780). When the new routing table is activated without delay, the router 15 stops the delay timer if it is already in force and the delay is aborted. When activation is delayed, the router 15 starts a delay timer if one is not already in force. If a delay timer is in force, the router 15 allows the delay timer to continue, i.e., remain in force, until expiration.

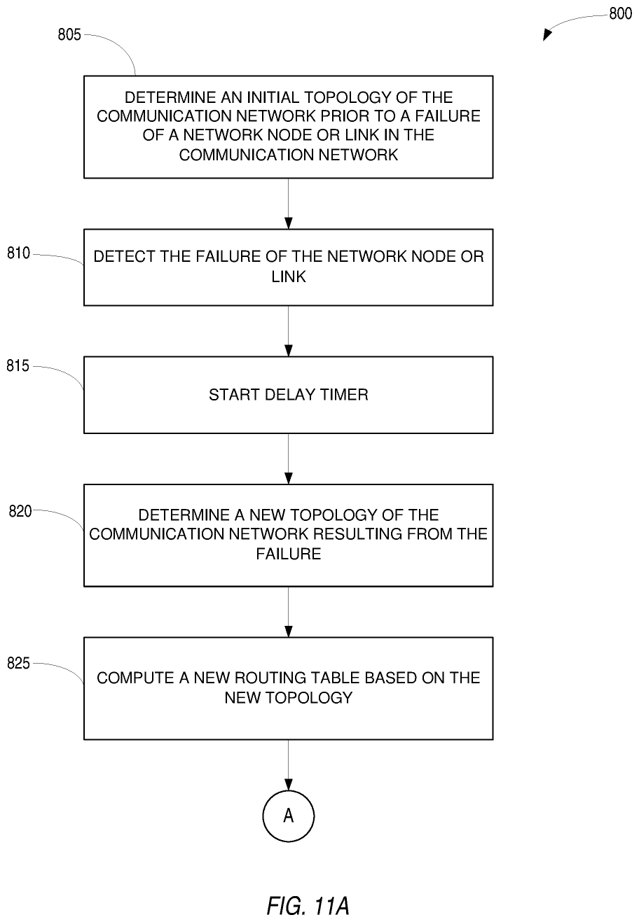

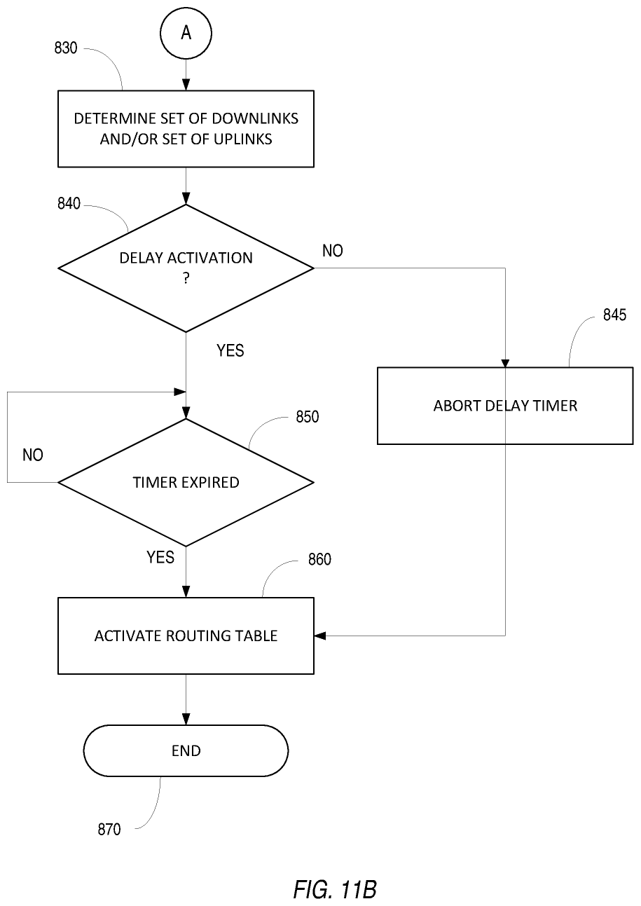

FIG. 11 illustrates another method 800 implemented by a router 15 according to one exemplary embodiment. The method 800 is used to make routing updates following a link or node failure. Prior to the failure of a link of node, the router 15 determines an initial network topology of the communication network (block 805). Subsequently, the router 15 detects the failure of a link or node (block 810). Responsive to detection of the link or node failure, the router 15 determines a new network topology resulting from the link or node failure and computes a new routing table based on the new topology (blocks 820 and 825). After computing the routing updates, the router 15 determines whether to delay activation of the new routing table based on a comparison of the new topology with the initial topology determined before the failure (blocks 830-860). In this example, the router 15 determines a set of downlinks and/or a set of uplink based on the comparison of the new network topology with the initial network topology (blocks 830 and 835). The router 15 then determines whether to delay activation of the new routing table based on the set of downlinks and/or set of uplinks (block 840). If activation is to be delayed, the router waits for expiration of the delay timer (block 850). When the timer has expired, the router 15 activates the new routing table (block 860). If, at block 840, the router 15 decides to activate the new routing table without delay, the router i5 aborts the delay timer (block 845) and activates the routing table without delay (block 860). The process ends after the routing table is activated (block 865).

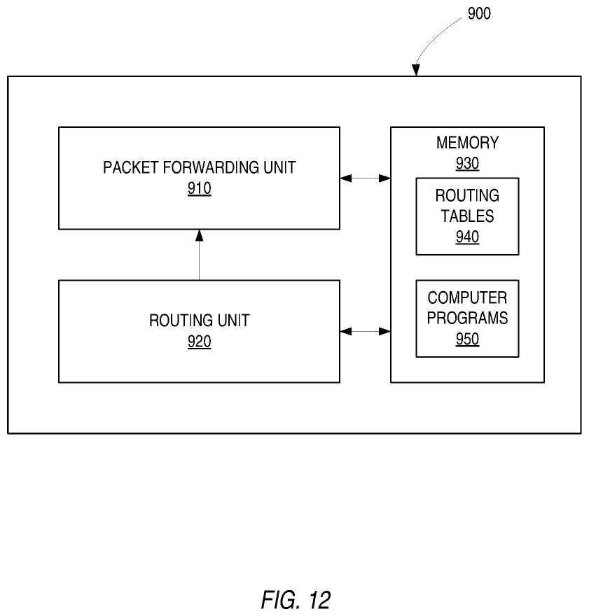

FIG. 12 illustrates an exemplary source router S indicated by the numeral 900. The source router S comprises a packet forwarding unit 910, a routing unit 920, and memory 930. The packet forwarding unit 910 includes a network interface and related processing circuitry for receiving and forwarding packets. The routing unit 920 comprises processing circuitry to compute the routing tables that are used by the packet forwarding unit 910 to forward packets. The routing unit 920 is configured in one embodiment to perform the methods shown in FIGS. 5-9. The processing circuitry for the packet forwarding unit 910 and routing unit 920 may, for example, comprise one or more microprocessors, hardware circuits, application-specific integrated circuits (ASICs), filed programmable gate arrays (FPGAs), or a combination thereof. The packet forwarding unit 910 and routing unit 920 may share processing resources. In some embodiments, the functions of the packet forwarding unit 910 and routing unit 920 may be implemented by a single microprocessor. In other embodiments, the functions of the packet forwarding unit 910 and routing unit 920 may be implemented by different microprocessors.

Memory 930 stores routing tables 940 used by the packet forwarding unit 910 to receive and forward packets and computer programs 950 to configure the packet forwarding unit 910 and routing unit 920. The computer programs 950 may comprise a packet forwarding program executed by the packet forwarding unit 910 to receive and forward packets, and a routing program executed by the routing unit 920 to compute the backup paths as herein described.

Embodiments of the present disclosure provide greater flexibility to network operators in handling events and allows network operators to implement their own policies in deciding whether to implement a delay or to abort a delay already in progress. Generally, aborting a delay is not desirable because it may lead to micro-loops. The techniques herein described enable network operators to apply a delay even though current practices would mandate that the delay be aborted.

1-33. (canceled)

34. A method implemented by a router in communication network of making routing updates, the method comprising the router:
determining an initial topology of the communication network prior to a failure of a network node or link in the communication network;
detecting the failure of the network node or link;
determining a new topology of the communication network resulting from the failure;
computing a new routing table based on the new topology; and
determining whether to delay activation of the new routing table based on a comparison of the new topology with the initial topology determined before the failure.

35. The method of claim 34, wherein determining whether to delay activation of the new routing table comprises:
determining, based on a comparison of the new topology with the initial topology, a set of downlinks that are available in the initial topology and unavailable in the new topology; and
determining whether to delay activation of the new routing table based at least in part on the set of downlinks.

36. The method of claim 35, further comprising activating the new routing table without delay if the set of downlinks is not null.

37. The method of claim 35, further comprising delaying activation of the new routing table if the set of downlinks comprises a single member representing a link incident to the router and for which a backup path is provisioned.

38. The method of claim 34, wherein determining whether to delay activation of the new routing table comprises:
determining, based on a comparison of the new topology with the initial topology before the network failure, a set of uplinks that are available in the new topology and unavailable in the initial topology; and
determining whether to delay activation of the new routing table based at least in part on the set of uplinks.

39. The method of claim 38, further comprising activating the new routing table without the delay if the set of uplinks is not null.

40. The method of claim 38, further comprising activating the new routing table without the delay if the set of uplinks comprises at least one member representing a link incident to the router.

41. The method of claim 38;
further comprising determining, based on a comparison of the new topology with the initial topology, a set of downlinks that are available in the initial topology and unavailable in the new topology; and
determining to delay activation of the new routing table if:
the set of downlinks comprises one member representing a link incident to the router and for which a backup path is provisioned; and
the set of uplinks is not null.

42. The method of claim 38, further comprising delaying activation of the new routing table if:
further comprising determining, based on a comparison of the new topology with the initial topology, a set of downlinks that are available in the initial topology and unavailable in the new topology; and
determining to delay activation of the new routing table if:
the set of downlinks comprises one member representing a link incident to the router and for which a backup path is provisioned; and
the set of uplinks comprises at least one member representing a link incident to the router.

43. The method of claim 34, further comprising:
starting a delay timer responsive to detection of the failure; and
controlling the delay timer based on the comparison of the new topology with the initial topology.

44. The method of claim 43, further comprising aborting the delay timer and activating the new routing table responsive to determining that activation of the new routing table should not be delayed.

45. The method of claim 43, further comprising:
waiting for expiration of the delay timer responsive to determining that activation of the new routing table should be delayed; and
activating the new routing table upon expiration of the delay timer.

46. The method of claim 34, wherein determining an initial topology of the communication network comprises constructing an initial topology graph representing the initial topology of the communication network.

47. The method of claim 34, wherein determining a new topology of the communication network as a result of the failure comprises constructing a revised topology graph representing the resulting topology of the communication network as a result of the failure.

48. A router in a packet-switched communication network, the router comprising:
a packet forwarding circuit configured to receive packets over the packet-switched communication network and forward the received packets toward a respective destination; and
a routing circuit configured to compute forwarding instructions for the packet forwarding circuit, the routing circuit being operative to:
determine an initial topology of the communication network prior to a failure of a network node or link in the communication network;
detect the failure of the network node or link;
determine a new topology of the communication network resulting from the failure;
compute a new routing table based on the new topology; and
determine whether to delay activation of the new routing table based on a comparison of the new topology with the initial topology prior to the failure.

49. The router of claim 48, wherein the routing circuit is configured to determine whether to delay activation of the new routing table by:
determining, based on a comparison of the new topology with the initial topology, a set of downlinks that are available in the initial topology and unavailable in the new topology; and
determining whether to delay activation of the new routing table based at least in part on the set of downlinks.

50. The router of claim 49, wherein the routing circuit is configured to activate the new routing table without delay if the set of downlinks is not null.

51. The router of claim 49, wherein the routing circuit is configured to delay activation of the new routing table if the set of downlinks comprises a single member representing a link incident to the router and for which a backup path is provisioned.

52. The router of claim 48, wherein the routing circuit is further to determine whether to delay activation of the new routing table by:
determining, based on a comparison of the new topology with the initial topology before the network failure, a set of uplinks that are available in the new topology and unavailable in the initial topology; and
determining whether to delay activation of the new routing table based at least in part on the set of uplinks.

53. A non-transitory computer readable recording medium storing a computer program product for controlling a router in communication network for making routing updates, the computer program product comprising program instructions which, when run on processing circuitry of the router, causes the router to:
determine an initial topology of the communication network prior to a failure of a network node or link in the communication network;
detect the failure of the network node or link;
determine a new topology of the communication network resulting from the failure;
compute a new routing table based on the new topology; and
determine whether to delay activation of the new routing table based on a comparison of the new topology with the initial topology determined before the failure.
